(19) United States
(12) Patent Application Publication
(10) Pub. No.: US 2015/0175453 A1
(43) Pub. Date: Jun. 25, 2015

(54) WASTEWATER TREATMENT UNIT AND METHOD

(71) Applicant: BIOPIPE TR CEVRE TEKNOLOJILERI AS, Istanbul (TR)

(72) Inventor: Mehmet Enes Kutluca, Istanbul (TR)

(73) Assignee: BIOPIPE TR CEVRE TEKNOLOJILERI AS, Istanbul (TR)

(21) Appl. No.: 14/411,744

(22) PCT Filed: May 6, 2013
(86) PCT No.: PCT/TR2013/000148

§ 371 Date: Dec. 29, 2014

(30) Foreign Application Priority Data
Jun. 28, 2012 (TR) 2012/07527

(51) Int. Cl. C02F 3/10

(52) U.S. Cl. CPC C02F 3/10; C02F 3/103; C02F 2103/005

(57) ABSTRACT

A treatment unit and method for treating wastewater by a bio-film process are disclosed. The treatment unit includes at least one treatment pipe through which wastewater being re-circulated and at least one drive section for providing re-circulation of the wastewater thorough the treatment pipe. The treatment pipe includes at least one pipe constituting the outer surface of the treatment pipe and at least one carrier medium where bio-film being grown thereon, complementing the shape of the internal volume of the pipe and/or occupying at least part of the internal volume of the pipe.

### SCOPE OF INVENTION

The present invention is related to a wastewater treatment unit and method for wastewater treatment by means of a bio-film process.

### FIELD OF THE INVENTION

Water consumption levels increase everyday as the technology advances and human population rises, so the wastewater generated should be treated at the point of discharge in order to avoid environmental problems. There are various methods to treat wastewater using a combination of physical, chemical and biological treatment processes. A conventional treatment combination is to subject the wastewater to a physical pre-treatment and then to a biological one as a second stage of process.

With the processes of biological treatment, the wastewater is in general taken into a container, tank or bio-reactor wherein microorganisms are utilized to convert the impurities existing in the wastewater to harmless end products such as carbon dioxide or water. It is possible to perform treatment within the system aerobically under supply of air or anaerobically without supply of air. In the biological processes, the impurities within the wastewater are converted into a microbial bio-mass. In order to ensure an effective treatment process and therefore to break down the impurities within the wastewater to a large extent, the amount of bio-mass including active microorganisms should be high and therefore, the bio-mass itself should be maintained in the process. In active sludge method being one of the common biological treatment processes, the bio-mass is grown in the form of a suspension. One of the significant drawbacks of this method is that the bio-mass escapes from the system as its precipitation qualities degrade and thus it should be returned to the system. Therefore, the active sludge method causes a high cost and time- and power consumption because of the additional operations it requires.

In the bio-film process wherein the bio-mass is grown on a carrier, the microorganisms generate a bio-film on the surfaces of the carrier and thus they are maintained and grown thereon in the system. The bio-film method results in both treatment with a higher performance as compared with the active sludge and other methods and is a less expensive one as compared with the active sludge method in that it requires no additional operations since there is no loss of bio-mass. The bio-film process uses significantly larger amounts of bio-mass and is much less sensitive to the variations in environmental conditions.

Bio-film layer is formed in large aeration basins at the facilities where huge amounts of wastewater being treated such as municipalities, hotels or large residential groups. Such treatment systems that use stone, sand, gravel or plastics as a carrier lead to large space losses and high installation and operation costs. The U.S. Pat. No. 6,126,829 discloses a treatment method using a carrier that is kept moving in the water. The said carrier has also a multi-particulate structure that allows flow of water there through. The said carrier is structured to be used in large aeration basins where the water is stored, but does not suggest a practical structure that is able to solve the problems mentioned above.

The so-called domestic wastewater treatment systems where smaller volumes of wastewater are treated use tanks for treatment operations. In these systems, the carrier materials are placed in the tank. Since the surface area of the carrier affects significantly the efficiency of the treatment process, large tanks are required and this leads to great space and volume losses. Furthermore, since tanks are difficult to transport and install, it is not so practical to replace or perform maintenance operations on tanks. Besides, the tank should be replaced whenever the volume of wastewater to be treated changes. However, tanks are mostly produced in standard sizes which are insensitive to the replacement needs. The U.S. Pat. No. 5,458,759 discloses a treatment method using a bio-film generated on a carrier within a reactor. The carrier therein has a multi-particulate structure in order to increase the surface area of the bio-film formed. In this method, when the treatment process proceeds anaerobically (without supply of oxygen), the water in the bio-reactor should be stirred with a blade stirrer or a circulation pump. The volume is limited by the volume of bioreactor involved. Therefore, increased bio-film surface area and the movement of water cannot provide a sufficient contact.

Consequently, there is still a need in the art for those wastewater treatment systems which both eliminate significant space losses and high costs of production and operation and provide a high performance treatment.

### BRIEF DESCRIPTION OF THE INVENTION

The present invention relates to a wastewater treatment unit and method in order to eliminate above-mentioned problems and to bring new advantages to the related technical field.

The main object of the present invention is to provide a wastewater treatment unit which does not lead to high costs of installation and maintenance or significant space losses and which is easily capable of being adapted to varying conditions.

In the light of the main object, another object of the present invention is to provide a wastewater treatment unit and method reducing the harm on environment caused by wastewater together with a high performance treatment.

In order to realize all of the above-mentioned objects and the objects which are to be obtained from the detailed description below, the present invention is related to a treatment unit in which the wastewater is treated by means of bio-film process. The treatment unit of the present invention comprises at least one treatment pipe through which wastewater being re-circulated and at least one drive means providing with the re-circulation of the wastewater through the treatment pipe.

The said treatment pipe comprises at least one pipe constituting the outer surface of the said treatment pipe and at least one carrier medium complementing the shape of the internal volume of the said pipe and/or occupying at least part of the said internal volume, where bio-film being grown thereon.

In order the embodiments and advantages of the present invention to be understood in the best manner, it may be evaluated with the figures and detailed description explained below.

### BRIEF DESCRIPTION OF THE FIGURES

The implementation of the present invention is explained with references to the appended figures:

FIG. 1—A general view of the treatment unit of the present invention.

FIG. 2a—A general view of the carrier media

FIG. 2b—A cross-sectional view of the treatment pipe

### DETAILED DESCRIPTION OF THE INVENTION

In this detailed description, the wastewater treatment unit (10) and method of the present invention are explained with references to examples without forming any restrictive effect in order to make the subject matter more understandable. Accordingly, a treatment unit (10) and a treatment method through a bio-film process described in hereunder description and the appended figures.

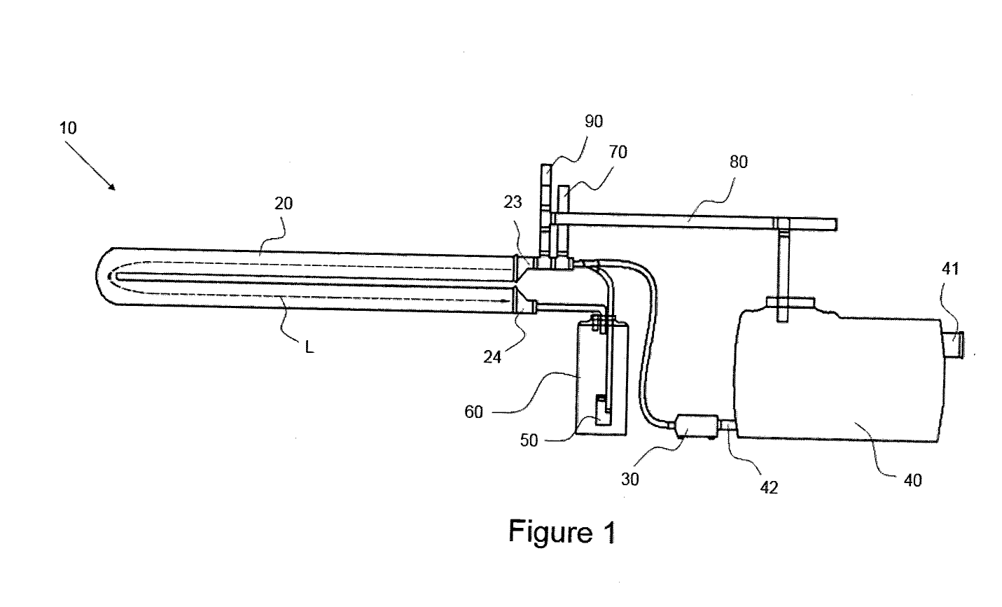

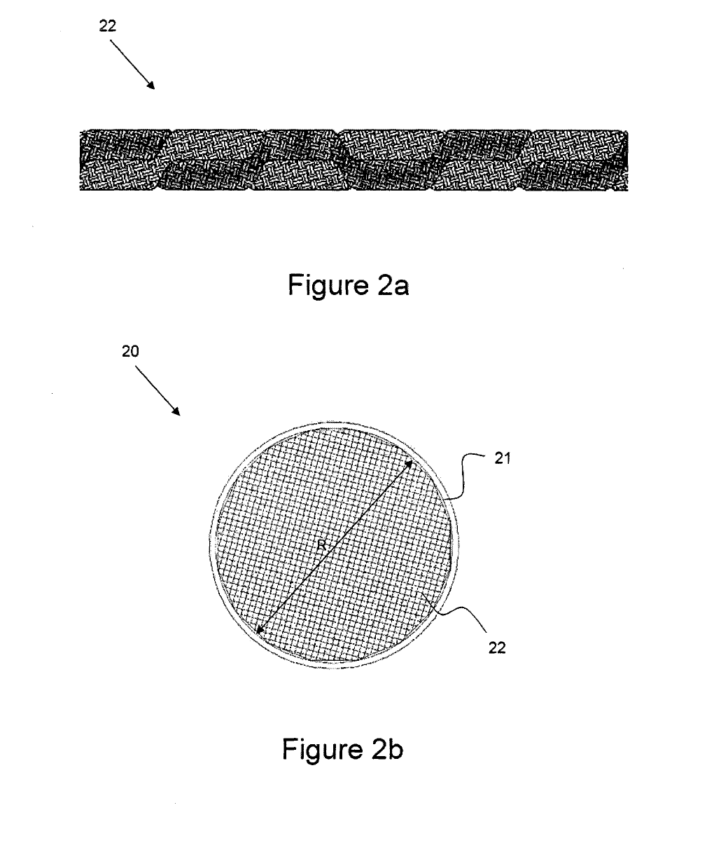

With reference to the FIGS. 1 and 2, the treatment unit (10) of the present invention comprises at least one treatment pipe (20) in which the wastewater is biologically treated. A treatment pipe (20) comprises at least one pipe (21) and carrier medium (22) which is placed interior of the pipe or pipes (21) and where a bio-film being grown thereon. The wastewater to be treated is re-circulated in the said treatment pipe (20).

A pipe (21) forming a treatment pipe (20) has a predetermined length (L) and a predetermined cross-section diameter (R). The said length (L) and cross-section diameter (R) are determined depending on several factors such as the average volume of the wastewater to be treated and the duration of treatment. Within the treatment unit (10) of the present invention, wastewater in a volume of the treatment pipe (20) is treated at each time. Therefore, it is possible to construct pipes (21) in varying volumes, sizes and shapes in order to provide treatment pipes (20) in varying volumes for different treatment units (10).

A treatment pipe (20) may be formed of one single piece or more than one piece. In case of a treatment pipe (20) comprising multiple interconnected pipes (21), it is possible to change the length (L) and/or cross-section diameter (R) of the pipe(s) (21) if the amount of wastewater to be treated is increased/decreased or the preferred rate of treatment is varied. For instance, it is possible to replace a pipe (21) with another one having a longer length (L) and/or to attach additional pipes to the existing pipe (21) in order to achieve more purified treated water.

Furthermore, it is possible to determine and vary as desired, the manner of the extension within a treatment unit (10), of a pipe (21) that constitutes a treatment pipe (20) depending on several factors such as the structure of the land on which the said treatment unit (10) has been built and the volume of water to be treated. For example, a treatment pipe (20) as shown in FIG. 1 can be constructed in a twisted shape to return to the point where it started or in a shape to extend straightforward.

A treatment unit (10) may comprise more than one treatment pipe (20). In a preferred embodiment of the present invention, the treatment unit (10) comprises multiple treatment pipes (20) that are located to extend in parallel to each other and in which the wastewater is re-circulated.

The number and structure of the pipes (21), which are not restricted to the embodiments given in the figures and examples, constituting a treatment pipe (20), and ease of the adaptability of the various embodiments of the pipes (21) to the said treatment unit (10) are among the essential features that make the treatment unit (10) of the present invention more advantageous than the treatment systems of the prior art.

With reference to the FIG. 2a, the carrier media (22) is placed interior of the said pipe (21) so as to occupy at least most of the internal volume of the pipe (21). The carrier media (22) extends all or almost all along the treatment pipe (20) in lengthwise (L) direction thereof. Accordingly, the carrier media (22) is in general structured so that it complements the shape of the internal volume of the pipe (21). Thereby, it is provided that wastewater flowing through the treatment pipe (20) contacts at a maximum level with the carrier media (22) and thus with the bio-film grown on the carrier media (22) as long as it is maintained in the treatment pipe (21). With regard to that in a preferred embodiment of the present invention, the carrier media (22) is formed by being knit in the form of a cat ladder that extends as an open network in the lengthwise (L) direction of the pipe (21). A representative view of the open network structure of the treatment pipe (20) and therefore the carrier media (22) is shown in FIG. 2b.

The number and structure of the carrier media (22), which are not restricted to the embodiments given in the figures and examples, constituting a treatment pipe (20) and the fact that the said carrier media (22) is structured so as to complement the shape of the internal volume of the said pipe (21) are among the essential features that make the treatment unit (10) of the present invention more advantageous than the treatment systems of the prior art.

A treatment pipe (20) comprises an inlet (23) through which the wastewater flows into the treatment pipe (20) and an outlet (24) through which the wastewater flows out of the treatment pipe (20). The wastewater is re-circulated between the inlet (23) and outlet (24) of the treatment pipe (20). The number and duration of re-circulation vary depending on the level of treatment desired which also depends on the level of contamination of the wastewater to be treated and on what purpose the treated water will be used.

The treatment unit (10) of the present invention comprises at least one drive means (30) to provide with proper re-circulation of the wastewater through the treatment pipe (20). The said drive means (30) provides with the transfer of the wastewater to the treatment pipe (20) and flow of it from the inlet (23) towards the outlet (24) through the treatment pipe (20). In a preferred embodiment of the present invention, the said drive means (30) is a pump that is connected with the inlet (23) of the treatment pipe (20) to re-circulate the wastewater through the treatment pipe (20).

The treatment unit (10) comprises a first tank (40) in which the wastewater coming from a house, group of houses or any other residential area is collected via a sewage drain (41). The said wastewater may comprise all or part, if desired, of the wastewater produced by a residential site including the so-called black water coming from the toilettes. The sewage drain (41) is in the form of a pipe structured by taking the volume of the wastewater to be treated into account and with a predetermined cross-section diameter (R) and a length (L), and transfers the predetermined volume of wastewater to the tank (40). The wastewater collected in the first tank (40) is initially subject to a physical pre-treatment process. Here, any garbage in the wastewater which are heavier than water such as toilet paper, tissues, rags, etc., settle at the bottom while wastes that are lighter than water accumulate on the surface of wastewater. Then the wastewater is transferred to the treatment pipe (20). For this purpose, the first tank (40) comprises an outlet (42). The said outlet (42) is located preferentially at the bottom of the first tank (40). Accordingly, the outlet (42) of the first tank (40) is connected with the inlet (23) of the treatment pipe (20) and the said first drive means (30) is located between the outlet (42) of the first tank (40) and the inlet (23) of the treatment pipe (20) or at any other point around the said outlet (42) of the first tank (40). In case of the first drive means (30) being a pump, the said drive means (30) is a pump with blades breaking up any organic solid wastes while transferring the same to the treatment pipe (20).

The treatment unit (10) comprises a second drive means (50) located between the inlet (23) and outlet (24) of the treatment pipe (20) in order to provide with a continuous re-circulation. In a preferred embodiment of the present invention, the said second drive means (50) is a pump. In case of the said second drive means (50) being a pump, in a more preferred embodiment of the present invention, the said second drive means (50) is a self-priming pump.

While the inlet (23) and outlet (24) of the treatment pipe (20) can be interconnected directly, in a preferred embodiment of the invention, the treatment unit (10) comprises a second tank (60) located between the said inlet (23) and outlet (24). Accordingly, the wastewater coming out of the treatment pipe (20) is first transferred to the second tank (60) and then re-transferred to the treatment pipe (20). In a further preferred embodiment of the present invention, the second drive means (50) is a submersible pump located in the second tank (60). In the treatment unit (10) of the present invention, the second tank (60) is provided depending on the structure of the second drive means (50) or all drive means (30, 50). For instance, in case of a self-priming pump being used as a second drive means (50), the second tank (60) is not required.

The treatment unit (10) of the present invention comprises a discharge opening (70). The said discharge opening (70) provides discharging of treated water from the treatment pipe (20). For this purpose, the discharge opening (70) is located around the inlet (23) of the treatment pipe (20). Furthermore, the treatment unit (10) comprises an air inlet opening (90) in order to fill the treatment pipe (20) with air when the wastewater in the treatment pipe (20) is discharged. The said air inlet opening (90) is located on the treatment pipe (20), downstream of the discharge opening (70) from the inlet (23) of the treatment pipe (20). Two solenoid valves (not shown in the figures), associated with the discharge opening (70) and the air inlet opening (90), respectively are used to discharge the treated water from the discharge opening (70) in a controlled manner. The valve associated with the air inlet opening (90) is in open position and the one associated with the discharge opening (70) is in closed position during treatment of wastewater through the treatment pipe (20). The valve associated with the air inlet opening (90) is in closed position and the one associated with the discharge opening (70) is in open position during discharge of the treated wastewater.

The treatment unit (10) comprises a control unit. The first drive means (30) and/or the second drive means (50) provide(s) a controlled re-circulation of the wastewater in the treatment pipe (20) by means of the said control unit.

The first drive means (30) starts transferring the wastewater to the treatment pipe (20) when the volume of collected wastewater in the first tank (40) reaches a specified threshold. The treatment unit (10) has at least one level switch (not shown in the figures) to indicate the wastewater level collected in the first tank (40). The said level switch is provided in the first tank (40) either as an integral or as a discrete structure with the first drive means (30) or as a stand-alone unit. The said level switch prevents dry operation of the drive means (30, 60).

The transfer of wastewater to the treatment pipe (20) continues at predetermined time intervals as long as the volume of collected wastewater in the first tank (40) is higher than a specified threshold. The wastewater is not transferred to the treatment pipe (20) when the volume of collected wastewater in the first tank (40) drops below a specified threshold. However, no more wastewater is transferred to the treatment pipe (20) from the first tank (40) until the wastewater already present in the treatment pipe (20) is completely treated. The wastewater in the treatment pipe (20) is re-circulated as long as desired and more wastewater is transferred from the first tank (40) to the treatment pipe (20) again after the treatment pipe (20) is discharged.

Accordingly, the control unit provides with power transmission to the first drive means (30), the second drive means (50) and the solenoid valves at predetermined times and/or time intervals and controlled operation of the components of the treatment unit (10) in accordance with their proper functions. In a preferred embodiment of the present invention, the said control unit is in the form of an electronic plug.

The treatment unit (10) also comprises a returning pipe (80) that connects the treatment pipe (20) with the first tank (40). The said returning pipe (80) provides with the transfer of excess wastewater back to the first tank (40) in case the wastewater transferred to the treatment pipe (20) becomes higher in volume than the volume of the treatment pipe (20). For this purpose, the returning pipe (80) provides with a connection between the treatment pipe (20) and the first tank (40) in order to transfer any excess wastewater from the first tank (40) to the treatment pipe (20). The said connection can be provided either directly with the treatment pipe (20) or through an air inlet opening (70) connected with the treatment pipe (20). By means of transferring excess wastewater back to the first tank, solid waste accumulation in the first tank is also prevented. For example, the bladed pump used as the first drive means (30) regularly continues to break up the organic solid wastes and the wastewater is transferred to the treatment pipe (20) in this way.

In the wastewater treatment method of the invention, the wastewater generated by a residential area is firstly collected in a tank (40). The collected wastewater is preferentially subjected to a physical pre-treatment process and any solid wastes that are heavier or lighter than the water itself, are separated from the wastewater. Then, wastewater is transferred by at least one drive means (30, 50) to a treatment pipe (21) being formed of a pipe (21) and carrier media (22) occupying at least part of the internal volume of the pipe (21), and treated by means of re-circulation. The volume of treated wastewater each time is equal to the volume of the treatment pipe (20). The duration of treatment depends on several factors such as the volume of the treatment pipe (20), number of re-circulation and flow rate of the wastewater through the treatment pipe (20), which can be varied as desired. It is also possible to subject treated wastewater to any other treatment processes in the scope of the treatment unit (20). For example, the wastewater discharged at the discharge opening (70) can be re-treated by an ultraviolet filter mounted at the said discharge opening (70). The wastewater can be subjected to various treatment processes before or after treatment in the treatment pipe (20), depending on the level of treatment desired.

The protection scope of the present invention is set forth in the annexed Claims and cannot be restricted to the illustrative disclosures given above, under detailed description a skilled person in the art shall readily recognize the innovation by utilizing similar embodiments without departing from the scope of the invention. It is because a person skilled in the related art can obviously produce similar embodiments under the light of the foregoing disclosures, without departing from the main principles of the present invention.

### REFERENCE NUMERALS

| | |
|---|---|
| 10 | Wastewater treatment unit |
| 20 | Treatment pipe |
| 21 | Pipe |
| 22 | Carrier media |
| 23 | Inlet |
| 24 | Outlet |
| 30 | Drive means |
| 40 | Tank |
| 41 | Sewage drain |
| 42 | Outlet |
| 50 | Drive means |
| 60 | Tank |
| 70 | Discharge opening |
| 80 | Returning pipe |
| 90 | Air inlet opening |
| L | Length of pipe |
| R | Cross-section diameter of pipe |

1-12. (canceled)

13. A treatment unit for treating wastewater by means of bio-film process, comprising: at least one treatment pipe through which wastewater being re-circulated and which has at least one pipe constituting the outer surface of the said treatment pipe, at least one drive means for providing re-circulation of the wastewater through the treatment pipe and at least one carrier medium where bio-film being grown thereon, complementing the shape of the internal volume of the said pipe and/or occupying at least part of the said internal volume wherein said carrier medium has a spaced structure adapted for the flow of wastewater throughout the carrier medium.

14. The treatment unit according to claim 13, comprising at least one tank connected to the treatment pipe through drive means wherein wastewater is stored prior to treatment.

15. The treatment unit according to claim 13, comprising an inlet through which the wastewater flows into the treatment pipe.

16. The treatment unit according to claim 13, comprising an outlet through which the wastewater in the treatment pipe flows out.

17. The treatment unit according to claim 13, comprising second drive means for re-circulation of wastewater between said inlet and outlet through the treatment pipe.

18. The treatment unit according to claim 13, comprising a discharge opening through which treated wastewater is discharged.

19. The treatment unit according to claim 13, comprising a second tank wherein wastewater coming out of the treatment pipe being transferred to the said second tank at the end of each circulation.

20. The treatment unit according to claim 13, comprising a returning pipe connecting the treatment pipe to the tank for transferring any excess wastewater back to the tank when the wastewater transferred from the tank to the treatment pipe is higher in volume than the volume of the treatment pipe.

21. The treatment unit according to claim 13, wherein the said treatment pipe comprises at least one air inlet opening for filling the treatment pipe with air in order to aerate the carrier media.

22. The treatment unit according to claim 13, wherein the said carrier media being structured in the form of an open network extending in the lengthwise direction of the pipe.

23. The treatment unit according to claim 13, wherein the said carrier media has an open network structure knit in the form of a cat ladder occupying at least a part of the internal volume of the treatment pipe, extending in the lengthwise direction of the pipe.

24. A wastewater treatment pipe comprising at least one pipe and at least one carrier medium where bio-film being grown thereon, complementing the shape of the internal volume of the said pipe and/or occupying at least part of the said internal volume wherein said carrier medium has a spaced structure adapted for the flow of wastewater throughout the carrier medium.

25. The wastewater treatment pipe according to claim 24 wherein the said carrier media is being structured in the form of an open network extending in the lengthwise direction of the pipe.

26. The wastewater treatment pipe according to claim 24 wherein said carrier media has an open network structure knit in the form of a cat ladder occupying at least a part of the internal volume of the treatment pipe, extending in the lengthwise direction of the pipe.

27. A wastewater treatment method for treating wastewater by means of bio-film process where a treatment unit is used, the treatment unit comprising at least one treatment pipe through which wastewater being re-circulated and which has at least one pipe constituting the outer surface of the said treatment pipe, at least one drive means for providing re-circulation of the wastewater through the treatment pipe and at least one carrier medium where bio-film being grown thereon, complementing the shape of the internal volume of the said pipe and/or occupying at least part of the said internal volume wherein said carrier medium has a spaced structure adapted for the flow of wastewater throughout the carrier medium, the wastewater treatment method comprising the following steps:
collecting wastewater in a tank;
transferring wastewater to the treatment pipe through the said drive means when the volume of collected wastewater reaches a specified threshold;
re-circulating wastewater through the treatment pipe by means of said one or more drive means; and
discharging treated wastewater through a discharge opening.

28. The treatment unit according to claim 14, comprising an inlet through which the wastewater flows into the treatment pipe.

29. The treatment unit according to claim 14, comprising an outlet through which the wastewater in the treatment pipe flows out.

30. The treatment unit according to claim 15, comprising an outlet through which the wastewater in the treatment pipe flows out.

31. The wastewater treatment pipe according to claim 25 wherein said carrier media has an open network structure knit in the form of a cat ladder occupying at least a part of the internal volume of the treatment pipe, extending in the lengthwise direction of the pipe.

32. The treatment unit according to claim 17, comprising a second tank wherein wastewater coming out of the treatment pipe being transferred to the said second tank at the end of each circulation.
